(19) United States
(12) Patent Application Publication
(10) Pub. No.: US 2022/0147972 A1
(43) Pub. Date: May 12, 2022

(54) SMART MASKS FOR DATA EXCHANGE

(71) Applicant: Michael Dershem, Voorhees, NJ (US)

(72) Inventor: Michael Dershem, Voorhees, NJ (US)

(21) Appl. No.: 17/480,542

(22) Filed: Sep. 21, 2021

Related U.S. Application Data
(60) Provisional application No. 63/204,275, filed on Sep. 22, 2020.

(51) Int. Cl. G06Q 20/32; A62B 18/08

(52) U.S. Cl. CPC G06Q 20/3278; A62B 23/025; A62B 18/084; A62B 18/08

(57) ABSTRACT

Masks having embedded electronic devices to allows for contactless payment for goods and services in an appropriate socially distanced manner.

### RELATED APPLICATIONS

This application claims the benefit of U.S. Provisional Patent Application Ser. No. 63/204,275 filed on Sep. 22, 2020, entitled Smart Masks For Data Exchange, the teachings of which are incorporated herein by reference.

### FIELD OF THE DISCLOSURE

The present disclosure relates generally to the field of protective face coverings. The present disclosure also relates to protective face coverings having capability to interact electronically with devices while avoiding physical contact with the devices.

### BACKGROUND OF THE DISCLOSURE

The physical handling of payments in face-to-face commerce, whether through currency exchange or the use of credit and debit cards, has always involved physical interaction of a person with another person or a machine reader frequently involving touching, or at least close personal contact and proximity. This type of activity is dangerous since an average person's hands carry at least 3000 different bacteria and viruses of varying species and types. Moreover, eighty percent of common infections are spread by hands. In fact, healthcare workers carry up to five million bacteria on each hand which can cause many different kinds of infectious diseases, and viruses remain on a person's hands long enough to also cause many deadly diseases which are easily spread person to person.

These issues have given rise to a need to devise ways to engage in commerce, while avoiding close physical contact and touching. To this end, the elimination of paper and coin currency has been proposed as well as the linking of digital wallets to scanning devices. However, these solutions are impractical since there will likely always be a need for the use of a credit card terminal requiring touching of the card to the terminal to make payments followed by, or at least involving, verification and authentication of the card owner's identity with a pen, finger or other physical interactions. This will inevitably require physical interaction with the card reader and the merchant. While the use of fingerprint readers has also been proposed, this modality also requires deep physical contact with the reader. Facial recognition has been touted as a solution to this problem, but with the advent of Covid-19 wherein masks cover people's faces, facial recognition is not practical.

### SUMMARY OF THE DISCLOSURE

Masks having embedded electronic devices solve the aforementioned needs. These masks, hereinafter referred to as “smart masks” will be best understood by reading the following Detailed Description of the Disclosure in conjunction with the Drawings, which are first described briefly below.

### BRIEF DESCRIPTION OF THE DRAWINGS

FIG. 1 is an isometric view of a smart mask in accordance with the disclosure.

FIG. 2 is a view of a user of a smart mask entering a business while maintaining appropriate social distance to utilize the smart mask to purchase goods or services.

FIG. 3 is a view of the smart mask of FIG. 1 interacting with an electronic reader.

### DETAILED DESCRIPTION OF THE DISCLOSURE

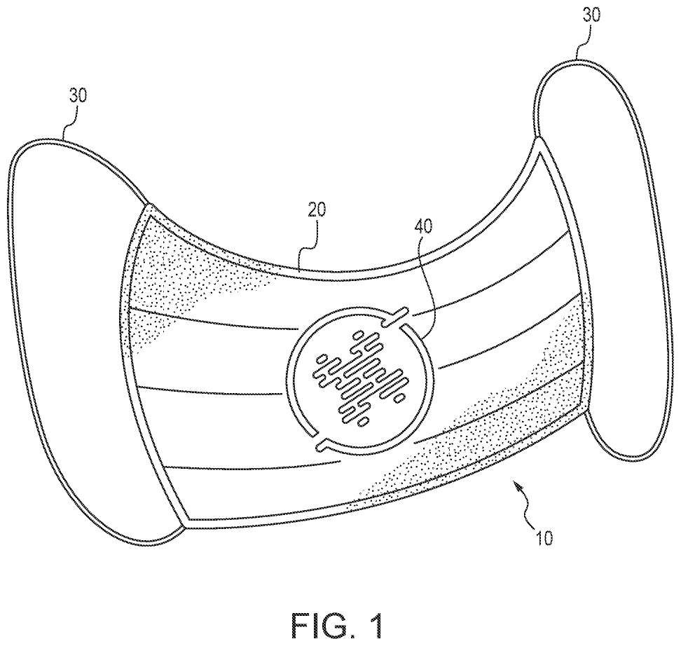

Referring to FIG. 1, a face covering or mask 10 is shown which is conventionally constructed of a paper, cloth, or cloth-like material so that mask 10 can be worn around a user's face to cover the user's mouth and nose. Conventionally, mask 10 protects people that the user will interact with from aspirants that will come from the user's mouth and nose when the user talks to other people. As is known, such aspirants contain many germs and viruses that cause serious and fatal diseases, for example, the coronavirus that causes Covid-19. Additionally, mask 10 may afford some protection to the user from environmental hazards of a similar nature insofar as mask 10 prevents germs and viruses from entering the user's mouth and nostrils when these germs and viruses are airborne. Using mask 10 and employing appropriate social distancing guidelines allows the user and people interacting with the user to remain safe from diseases caused by airborne germs and viruses.

Conventionally, mask 10 is constructed of a soft, pliable material 20 such as paper, cloth or a cloth-like material that can cover a use's mouth and nose to prevent aspirants from emerging into the air from the user's mouth or nose due to, for example, talking, singing, coughing or sneezing. Any appropriate material that provides some form of protection in this manner is appropriate. Loops or strings 30 are affixed to the pliable material 20 and are intended to secure the mask around the user's ears to affix the mask 10 in a firm manner to the user's head. It will be appreciated that loops 30 are flexible and can be made of an elastic material which can be adjustable to fit on the user's ears. Alternatively, multiple strings (not shown) may be used instead of loops 30 to secure the mask to the user's head such that the user simply ties the strings in knots to secure mask 10 the user's head. Any arrangement that is appropriate to secure the mask to the user's head may be used.

It will be appreciated that the present disclosure is intended to also cover other kinds of face coverings or masks 10, for example, scarves and rigid face shields. In the case of a scarf, loops 30 will not be used to secure the face covering to the head. Rather, the scarf itself will have ends that can be tied around the head to secure the face covering 20 thereto. The scarf will also be made of a soft, pliable material 20. Alternatively, a rigid face covering 10 is within the scope of the disclosure. In the case of a rigid face covering or mask 10, material 20 is not soft and pliable, but instead is constructed of a rigid, plastic or plastic-like material which the user can see through when the face covering, or mask is secured to the user's head. In this case, the face covering or mask 10 will be somewhat heavier and so loops 30 will not be used to secure the face covering or mask 10 to the user's head, but a more sturdy band, strap or other type of mechanism may be used to ensure that the face covering or mask 10 is secured to the user's head. All such embodiments are within the scope of the present disclosure.

The mask 10 is further constructed to include an electronic device 40 sewn or otherwise secured to the pliable material 20. The electronic device 40 may be an active or passive electronic device that allows the user to interact with a payment device 50 in an appropriate socially distant manner to allow the user to pay for goods or services at the payment device. Electronic device 40 may be, for example, and electronic semiconductor chip adapted to interact with the payment device 50, a small, printed circuity board adapted to interact with the payment device, a flexible printed circuit board adapted to interact with the electronic device, or any other electronic device that is attachable to the pliable material 20 by a glue, stitching or similar modality. The electronic device may be a readable bar code or quick code known to those skilled in the art depending on the capabilities of the payment device that will read electronic device 40.

Electronic device may be in the form of a logo having the appropriate digital circuitry contained therein to interact with the payment device. Such a logo is the purple digital cross that has embedded quick response (QR) codes that act as a trigger for payment and data exchange when the user is interacting with a face-to-face payment encounter or activity. This logo is owned by, for example, MKDip LLC and licensed to MAPAY, Inc. of Voorhees, N.J. The quick codes can be embedded at time of manufacturing or placed on mask 10 in a replaceable or reloadable fashion. Each code is uniquely identified when the consumer first registers and receives their masks. The mask 10 may be tied to a user account where a smart digital wallet is accessed. Other self-authorized information could also be provided as well. For instance, in a healthcare setting instead of using a paper and pen, iPad, or kiosks for providing patient intake forms and insurance information, the masks and electronic devices described herein could be utilized to store the user or patient information for each user or patient in a personalized manner and the electronic device could transfer that information to the network in a touch-free manner. It would also be possible for the masks to be branded to a company, association, or organization as well.

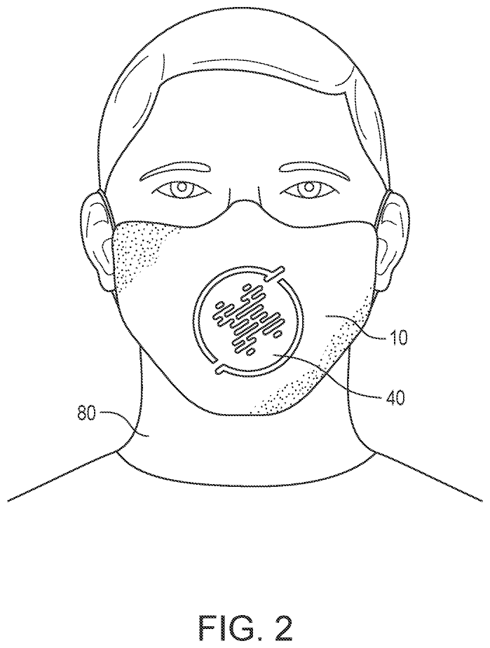

FIG. 2 shows a user 80 wearing mask 10 as the user makes his or her way into an establishment to purchase goods or services. The QR codes are embedded in electronic device 40 and as the user maintains safe social distancing, the goods and services may be paid for to avoid touching through a payment device which is adapted to read the QR codes. This allows the user to completely avoid all contact with other people in the premises, protecting the user from germs and viruses on the surface of the payment device and other surfaces in the place of business, as well as protecting others in the place of business from the user due to the user wearing the mask 10.

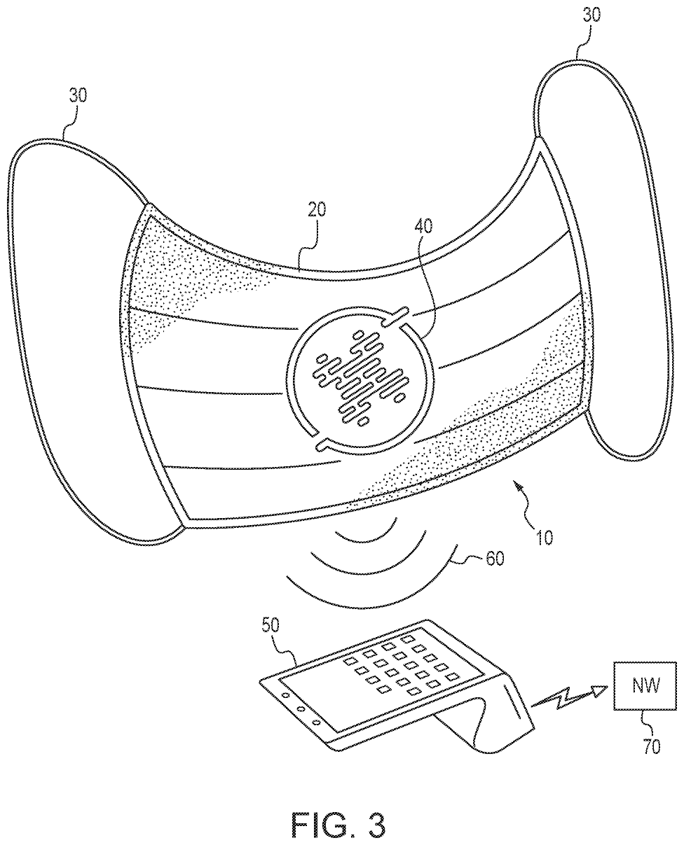

FIG. 3 shows mask 10 in operation as the user 80 pays for the goods and services using electronic device 40. The electronic device 40 may be a near-field communication (NFC) device, a Wi-Fi device, a Bluetooth device, a 4G, 5G, 3GPP or other electronic device which can communicate by emission or reception of electromagnetic communication waves 60. Whether the device 40 emits or receives waves 60 will be dependent on the nature of payment device 50 that electronic device 40 is intended to interact with. Any type of reciprocal payment device 50 may be used with mask 10 and electronic device 40 so long as the electronic device 40 is adapted to communicate with payment device 50. When QR codes are used in electronic device 40, then payment device 50 scans electronic device 40 so that data and information can be exchanged between the two devices to effect payment for goods or services. Once the payment device 50 gathers this information, and the user pays for the goods or services, the payment device 50 may interact with a network 70 to finally process the payment,

As will be appreciated by those skilled in the art, the systems, apparatus, and methods described herein can be implemented in hardware, software or firmware, or combinations of these modalities, in order to provide flexibility for various environments as discussed throughout this disclosure. Application specific integrated circuits (ASICs), programmable array logic circuits, discrete semiconductor circuits, processors configured to perform inventive functions, and programmable digital signal processing circuits, computer readable media, transitory or non-transitory, among others, may all be utilized to implement the present invention. These are all non-limiting examples of possible implementations of the several preferred embodiments of the present principles, and it will be appreciated by those skilled in the art that other embodiments may be feasible.

There have thus been described certain preferred embodiments of methods and apparatus for healthcare universal patient payment gateways. While preferred embodiments have been described and disclosed, it will be appreciated by those with skill in the art that modifications are within the true spirit and scope of the described principles.

What is claimed is:

1. A face covering, comprising:
a material adapted to cover at least a nose and mouth of a user wearing the mask and which substantially prevents aspirants from traversing the user's nose and mouth through the material;
an electronic device secured to the material that allows the user to interact with another device.

2. The face covering recited in claim 1, further comprising an adjustable material securing device affixed to the material to allow the user to secure the mask to the user's face so that the mask securely covers the user's nose and mouth.

3. The face covering recited in claim 2, further comprising a communication device in communication with the electronic device allowing the user of the mask to communicate data to a reciprocal device.

4. The face covering recited in claim 3, wherein the communication device is one of a 3GPP device, a near-field communication device, a WIFI device and a Bluetooth device.

5. The face covering recited in claim 4, wherein the reciprocal device is a payment device.

5. The face covering recited in claim 5, wherein the electronic device is one of an electronic semiconductor chip adapted to interact with the payment device, a small, printed circuit board adapted to interact with the payment device, a flexible printed circuit board adapted to interact with the payment device, a readable bar code, a quick code and a quick response (QR) code.

6. The face covering recited in claim 5, wherein the material is one of a soft, pliable material, paper, cloth, and a rigid material, plastic.

7. The face covering recited in claim 6, wherein the adjustable material is one of a loop, strap, band and a plastic material.

8. The face covering recited in claim 7, wherein the electronic device comprises a logo having digital circuitry contained therein to interact with the payment device.

9. The face covering recited in claim 1, wherein the material is a scarf

10. The face covering recited in claim 1, wherein the electronic device is adapted to store user information and to transfer the user information to a network in a touch-free manner.

11. A system for communicating data in a touch free manner, comprising:
a face covering comprising a material adapted to cover at least a nose and mouth of a user wearing the mask and which substantially prevents aspirants from traversing the user's mouth nose and mouth through the material, and an electronic device secured to the material that allows the user to interact electronically in a touch free manner; and
a reciprocal electronic device adapted to receive data transmitted from the electronic device secured to the material that allows the user to interact in the touch free manner.

12. The system recited in claim 11, further comprising an adjustable material securing device affixed to the material to allow the user to secure the mask to the user's face so that the mask securely covers the user's nose and mouth.

13. The system recited in claim 12, further comprising a communication device in communication with the electronic device allowing the user of the mask to communicate data to the reciprocal device.

14. The system recited in claim 13, wherein the electronic device is adapted to store user information and to transfer the user information to a network in a touch-free manner.

15. The system recited in claim 14, wherein the communication device is one of a 3GPP device, a near-field communication device, a WIFI device and a Bluetooth device.

16. The system recited in claim 15, wherein the reciprocal device is a payment device.

17. The system recited in claim 16, wherein the electronic device is one of an electronic semiconductor chip adapted to interact with the payment device, a small, printed circuit board adapted to interact with the payment device, a flexible printed circuit board adapted to interact with the payment device, a readable bar code, a quick code and a quick response (QR) code.

18. The system recited in claim 17, wherein the material is one of a soft, pliable material, paper, cloth, and a rigid material, plastic.

19. The system recited in claim 18, wherein the adjustable material is one of a loop, strap, band and a plastic material.

20. The system recited in claim 19, wherein the electronic device comprises a logo having digital circuitry contained therein to interact with the payment device.
